(19) United States
(12) Patent Application Publication
(10) Pub. No.: US 2023/0234630 A1
(43) Pub. Date: Jul. 27, 2023

(54) OPERATION DEVICE

(71) Applicant: KABUSHIKI KAISHA TOKAI-RIKA-DENKI-SEISAKUSHO, Niwa-gun, Aichi (JP)

(72) Inventors: Takehiro WATANABE, Aichi (JP); Seiji ISHIGAKI, Aichi (JP); Hiroshi UENO, Aichi (JP); Tomoya YOSHIDA, Aichi (JP); Muneyoshi KAKIMI, Aichi (JP); Seiji KONDO, Aichi (JP); Yuichi SAHASHI, Aichi (JP); Toru KOSHIMIZU, Aichi (JP)

(21) Appl. No.: 17/919,014

(22) PCT Filed: Mar. 29, 2021
(86) PCT No.: PCT/JP2021/013315

§ 371 Date: Oct. 14, 2022

(30) Foreign Application Priority Data
Apr. 17, 2020 (JP) 2020-073979

(51) Int. Cl. B62D 1/04; B62D 15/02; B60W 50/14; B60W 60/00

(52) U.S. Cl. CPC B62D 1/04; B62D 15/0225; B60W 50/14; B60W 60/001

(57) ABSTRACT

An operation device for a vehicle includes an operation body configured to be displaced by being operated so as to turn the vehicle according to a displacement of the operation body while the vehicle is being manually operated, a detector configured to detect the displacement of the operation body so as to turn the vehicle according to the displacement of the operation body while the vehicle is being manually operated, and a determination section configured to determine a state of the operation body and the detector based on the displacement of the operation body as detected by the detector while the vehicle is in non-manual operation.

### TECHNICAL FIELD

The present invention relates to an operation device for operating an operation target when traveling manually.

### BACKGROUND ART

In a vehicle power-assisted steering device of Japanese Patent No. 6596615, when a command to switch to a self-driving mode is received, a control device thereof determines whether or not a self-driving function of a self-driving vehicle is normal. The control device also determines normal in cases in which a command from a driving position device is normal, disposes a steering wheel in a self-driving position (stowed position), and suppresses actions of an operation body for steering the vehicle during travel in the self-driving mode.

### SUMMARY OF INVENTION

### Technical Problem

However there are proposals for vehicles that travel in self-driving mode without intervention of driving operations of an occupant from travel start through to travel end. In such vehicles, normally travel is in the self-driving mode, and travel by driving operations by an occupant is enabled by the self-driving mode being stopped (a switch can be made to manual driving mode).

However, in cases in which the actions of the operation body for steering the vehicle are suppressed and the operation body is not being rotationally operated during travel in the self-driving mode, it is unclear whether or not the operation body is able to be operated (moveable state) when the self-driving mode is stopped.

In consideration of the above circumstances, the present disclosure provides an operation device capable of ascertaining whether or not the operation body is in an operable state in the manual driving mode.

### Solution to Problem

An operation device for a vehicle of a first aspect of the present disclosure includes an operation body configured to be displaced by being operated so as to turn the vehicle according to a displacement of the operation body while the vehicle is being manually operated, a detector configured to detect the displacement of the operation body so as to turn the vehicle according to the displacement of the operation body while the vehicle is being manually operated, and a determination section configured to determine a state of the operation body and the detector based on the displacement of the operation body as detected by the detector while the vehicle is in non-manual operation.

An operation device for a vehicle of a second aspect is in the first aspect, wherein the determination section determines whether or not a displaced position of the operation body as detected by the detector indicates a pre-defined position of the operation body.

An operation device for a vehicle of a third aspect is in the first aspect or the second aspect, wherein the operation device further includes a request section configured to request a specific operation of the operation body when in the non-manual operation, and the determination section determines whether or not a displacement of the operation body corresponding to the request has been detected by the detector.

An operation device for a vehicle of a fourth aspect is in any one of the first aspect to the third aspect, further including a notification section configured to provide notification of a determination result of the determination section.

An operation device for a vehicle of a fifth aspect is an operation device for a vehicle configured to be operated manually by an occupant and to be operated by automated control. The operation device includes a memory, a processor coupled to the memory, an operation body configured to turn the vehicle according to operation of the occupant, and a detector configured to detect displacement of the operation body. When the vehicle is being operated by automated control, the processor is configured to determine a state of the operation body, the detector, or any combination thereof, based on a position of the operation body as detected by the detector.

An operation device for a vehicle of a sixth aspect is in the fifth aspect, wherein the processor determines the state of the operation body, the detector, or any combination thereof, based on whether or not the position of the operation body as detected by the detector indicates a pre-defined position of the operation body.

An operation device for a vehicle of a seventh aspect is in the fifth aspect or the sixth aspect, wherein in a case in which the position of the operation body is determined not to be at the pre-defined position of the operation body when the vehicle is being operated by automated control, the processor is configured to output an instruction to perform a specific operation on the operation body, and re-determine a state of the operation body, the detector, or any combination thereof, based on a position of the operation body as detected by the detector after the specific operation has been performed on the operation body.

An operation device for a vehicle of an eighth aspect is in any one of the fifth aspect to the seventh aspect, wherein in a case in which the position of the operation body has been determined not to be at the pre-defined position of the operation body when the vehicle is being operated by automated control, the processor provides notification of this determination result to the occupant of the vehicle.

In the operation device of the first aspect, the displacement of the operation body displaced by being operated is detected by the detector. The vehicle is accordingly turned according to a displacement by displacing the operation body while being manually operated.

The determination section determines a state of the operation body and the detector based on the displacement of the operation body as detected by the detector while the vehicle is in non-manual operation. This thereby enables whether or not the operation body and the detector are in a state that enables steering of the vehicle in the manual driving mode to be ascertained while the vehicle is in the non-manual operation.

In the operation device of the second aspect, the state of the operation body and the detector is determined based on whether or not the displaced position of the operation body as detected by the detector indicates the pre-defined position of the operation body. There is accordingly no need to provide a separate means for determining the state of the operation body and the detector.

In the operation device of the third aspect, the request section requests a specific operation of the operation body when in non-manual operation. The determination section determines whether or not the displacement of the operation body according to the request has been detected by the detector. Whether or not the displacement of the operation body can be detected by the detector is accordingly be determined, and whether or not the operation body and the detector are in a state enabling steering of the vehicle in the manual driving mode can be ascertained.

The operation device of the fourth aspect includes a notification section configured to provide notification of the determination result of the determination section. This thereby enables transition from the non-manual operation to manual operation to be restricted in cases in which the operation body and the detector are not in a state enabling steering of the vehicle.

In the operation device for a vehicle of the fifth aspect, when the vehicle is operating by automated control, the processor determines the state of the operation body, the detector, or any combination thereof, based on the position of the operation body as detected by the detector. When changing from operating by automated control to manual driving by the occupant, whether or not the operation body and the detector are in a state that enables steering of the vehicle by the occupant can be ascertained while the vehicle is operated by automated control.

In the operation device for a vehicle of the sixth aspect, the state of the operation body, the detector, or any combination thereof, is determined based on whether or not the position of the operation body as detected by the detector indicates the pre-defined position of the operation body. There is accordingly no need to provide a separate means to determine the state of the operation body and the detector.

In the operation device for a vehicle of the seventh aspect, in a case in which the position of the operation body is determined not to be at the pre-defined position of the operation body, the processor outputs the instruction to perform the specific operation on the operation body, and re-determines a state of the operation body, the detector, or any combination thereof, based on the position of the operation body as detected by the detector after the specific operation has been performed on the operation body. This thereby enables whether or not the operation body and the detector are in a state that enables steering of the vehicle by the occupant to be ascertained when changing from operating by automated control to manual driving by the occupant.

In the operation device of the eighth aspect, in a case in which the position of the operation body has been determined not to be at the pre-defined position of the operation body when the vehicle is being operated by automated control, the processor provides notification of this determination result to the occupant of the vehicle. This enables the occupant to ascertain that a change from operating by automated control to manual operation by the occupant is unable to be performed in cases in which the operation body and the detector are not in a state enabling steering of the vehicle by the occupant.

### BRIEF DESCRIPTION OF DRAWINGS

FIG. 1 is a schematic configuration diagram illustrating a steering system employed in the present exemplary embodiment.

FIG. 2 is a diagram illustrating a schematic flow of operation processing of a steering device.

FIG. 3A is a diagram illustrating a flow of an example of self-diagnostic processing.

FIG. 3B is a diagram illustrating a flow of another example of self-diagnostic processing.

FIG. 4 is a schematic block diagram illustrating a hardware configuration of a steering system applied in the present exemplary embodiment.

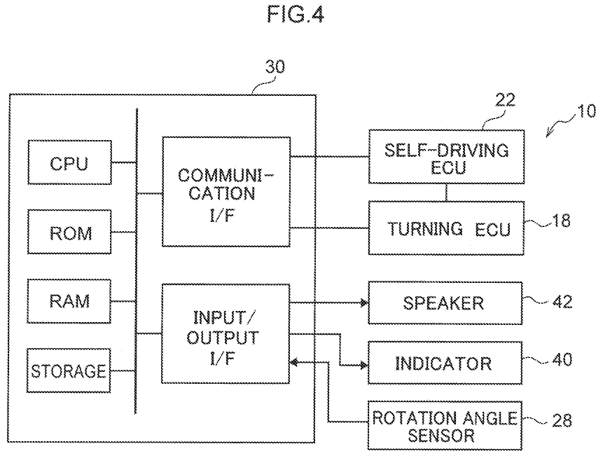

### DESCRIPTION OF EMBODIMENTS

Detailed description follows regarding an exemplary embodiment of the present invention with reference to the drawings.

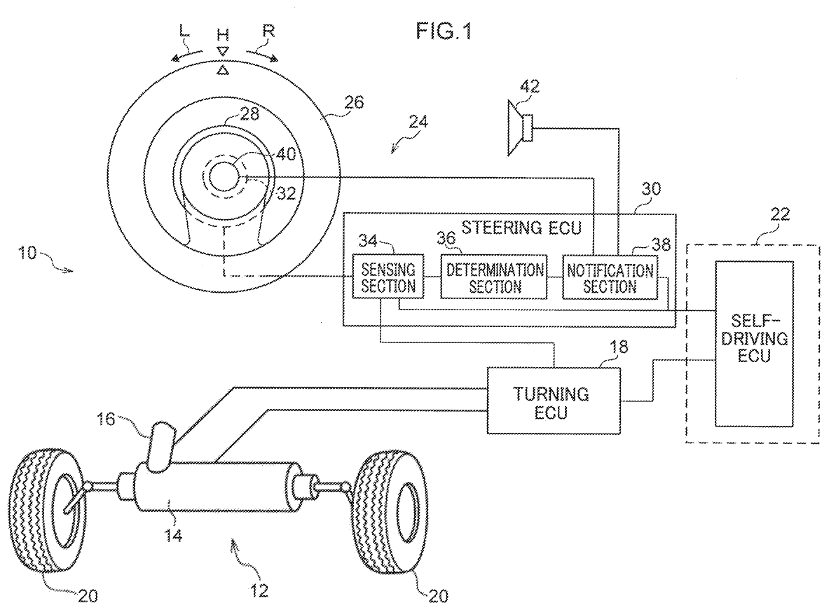

The present exemplary embodiment will be described for an example of a steering system 10 for changing a travel direction (changing course) of a vehicle. FIG. 1 is schematic configuration diagram illustrating the steering system 10 according to the present exemplary embodiment.

A vehicle installed with the steering system 10 according to the present exemplary embodiment is a vehicle that travels without the intervention of driving operations by an occupant (a self-driving vehicle). As illustrated in FIG. 1, the steering system 10 includes a turning section 12 serving as a turning device. The turning section 12 includes a turn actuator 14 serving as a turning operation section, a turn angle sensor 16 serving as a turn angle detection section, and a turning ECU 18 serving as a turning control section.

The turn actuator 14 is coupled to left and right turnable wheels 20 (front wheels, for example) of the vehicle through a non-illustrated link mechanism. The travel direction of the vehicle is changed (turned) when the turnable wheels 20 are turned by operation of the turn actuator 14. The turn angle sensor 16 detects (senses) the turn angle of the turnable wheels 20 turned by the turn actuator 14.

The turn actuator 14 and the turn angle sensor 16 are electrically connected to the turning ECU 18. By input of turn information (a turn signal), the turning ECU 18 controls operation of the turn actuator 14 such that the turn angle detected by the turn angle sensor 16 corresponds to the turn angle of the turn information.

The vehicle installed with the steering system 10 includes a vehicle control system configured to control self-driving travel and the like. A self-driving control section (a self-driving ECU 22 for example) in the vehicle control system performs vehicle speed control, braking control, steering control, and the like without intervention of driving operations of an occupant and enables the vehicle to travel in self-driving mode.

The turning ECU 18 is electrically connected to the self-driving ECU 22 and the self-driving ECU 22 performs turn control through the turning ECU 18 to turn the wheels 20. When the vehicle is traveling in self-driving mode, the self-driving ECU 22 outputs information (a self-driving signal) indicating that self-driving mode is being operated, and also outputs turn information (a steering angle signal) to the turning ECU 18 for steering the vehicle. While being input with the self-driving signal, the turning ECU 18 operates the turn actuator 14 according to the turn signal input from the self-driving ECU 22, such that the self-driving ECU 22 performs vehicle steering control.

By the self-driving ECU 22 stopping operation in the self-driving mode, the vehicle transitions to the manual driving mode traveling according to driving operations of an occupant. The vehicle is provided with a vehicle velocity device for controlling the vehicle speed, a braking device for controlling braking of the vehicle (neither illustrated in the drawings), and the like under driving operations of the occupant, and the self-driving ECU 22 stopping the self-driving mode enables the vehicle speed control and the braking control to be performed according to the occupant driving operations using the vehicle velocity device and the braking device. In the vehicle, the steering system 10 is employed for steering control when the self-driving mode has been stopped.

The steering system 10 according to the present exemplary embodiment includes a steering section 24 serving as a steering apparatus and a steering device. A handle 26 serving as an operation body and as a steering body, a rotation angle sensor 28 serving as a detector, and a steering ECU 30 are provided at the steering section 24.

The handle 26 is formed in a circular annular shape (ring shape), and a shaft 32 is coupled to an axial center portion of the handle 26 such that the handle 26 and the shaft 32 can be rotated integrally. The shaft 32 is rotatably attached to a non-illustrated case of the steering section 24. The handle 26 is thereby attached to the vehicle body through the case of the steering section 24, and the handle 26 is able to rotate about an axis of the shaft 32.

The rotation angle sensor 28 detects (senses) the rotation angle of the shaft 32 rotating together with the handle 26, thereby detecting the rotation angle of the handle 26.

The handle 26 has a size (outer diameter size) capable of rotational operation by one hand of the occupant, with the outer diameter of the handle 26 smaller than the outer diameter of a normal steering wheel. An intermediate position in the rotation range of the handle 26 is set for a home position serving as an initial position of the handle 26. The handle 26 is capable of rotational operation over a specific angular range of rightward rotation (the direction of arrow R) and leftward rotation (the direction of arrow L) centered on the home position.

Note that in FIG. 1 the handle 26 is illustrated in a state disposed at the home position. A detent mechanism, friction mechanism, or the like is provided at the handle 26 so as to suppress displacement from the home position by vehicle vibration or the like, and such that a feeling of stable operation is obtained when the handle 26 is rotationally operated.

The handle 26 is provided at the vehicle instead of a steering wheel, and is disposed at a front side of the occupant (driver) seated in a driving seat. This thereby enables the handle 26 to be rotationally operated by the occupant.

The steering ECU 30 includes a microcomputer (not illustrated in the drawings) including a CPU, ROM, RAM, and storage serving as non-volatile memory connected together by a bus. The steering ECU 30 configures a sensing section 34, a determination section 36, and a notification section 38. In the steering ECU 30, the CPU reads a program stored on the ROM or in the storage, expands the program into the RAM, and implements the functions of the sensing section 34, the determination section 36, and the notification section 38 by executing the program.

The rotation angle sensor 28 is electrically connected to the steering ECU 30, and an electrical signal output from the rotation angle sensor 28 is input to the sensing section 34 of the steering ECU 30. The steering section 24 includes an indicator 40 and a speaker 42 serving as a notification section, with the speaker 42 also functioning as a request section. The indicator 40 and the speaker 42 are electrically connected to the steering ECU 30.

The steering ECU 30 is electrically connected to both the self-driving ECU 22 and the turning ECU 18. The self-driving ECU 22 outputs information (a self-driving signal) to the steering ECU 30 to indicate that the self-driving mode is in operation when the vehicle is traveling in self-driving mode. When stopping vehicle travel in the self-driving mode, the self-driving ECU 22 acquires an operational state of the vehicle velocity device and braking device, and outputs information (a travel state signal) to the steering ECU 30 to indicate the travel state of the vehicle (the vehicle travel speed, for example).

By being input with the travel state signal when the self-driving signal is stopped, the steering ECU 30 outputs to the turning ECU 18 the travel state signal that was input, together with a rotation angle signal of the handle 26 detected by the rotation angle sensor 28. The turning ECU 18 uses the travel state signal and the rotation angle signal as turn information (a turn signal) to operate the turn actuator 14 according to the travel state signal and the rotation angle signal.

By stopping the self-driving mode, the vehicle thereby travels steered by operation of the handle 26. Note that although in the present exemplary embodiment the steering ECU 30 outputs the travel state signal and the rotation angle signal to the turning ECU 18, there is no limitation thereto, and a configuration may be adopted such that the steering ECU 30 outputs the rotation angle signal to the self-driving ECU 22, and the self-driving ECU 22 outputs a steering signal generated based on the rotation angle signal to the turning ECU 18.

The determination section 36 performs self-diagnostics on the steering section 24 to determine the state of the handle 26 and the rotation angle sensor 28 at a pre-set timing while the vehicle is traveling in self-driving mode.

A light emitting element such as an LED or the like is employed for the indicator 40, and the indicator 40 is disposed at an axial center portion of the handle 26. The speaker 42 is provided as a notification section and a request section, and the speaker 42 may be disposed on the handle 26 together with the indicator 40, and may also be disposed on an instrument panel (dashboard). A speaker of another system, such as a vehicle audio system or navigation system, may also be employed as the speaker 42. The indicator 40 is not limited to being provided on the handle 26, and may be provided at any site easily visible by the occupant, such as on the instrument panel.

The notification section 38 controls the illumination and illumination color (light emission color) of the indicator 40 according to the result determined by the determination section 36 and the vehicle driving mode. The notification section 38 also outputs the result determined by the determination section 36 to the self-driving ECU 22. The notification section 38 may provide notification to the occupant by emitting information from the speaker 42 according to the result determined by the determination section 36.

Next, description follows regarding operation of the present exemplary embodiment.

In the steering system 10 according to the present exemplary embodiment, the turning ECU 18 controls operation of the turn actuator 14 according to the turn signal input from the self-driving ECU 22 when the vehicle is traveling in self-driving mode. The travel of the vehicle is thereby controlled by the self-driving ECU 22, and the vehicle travels without intervention of driving operations of the occupant.

However, travel of the vehicle in self-driving mode is limited in situations in which there is insufficient infrastructure for automated travel of vehicles, such as when loading or unloading vehicles to/from a cargo ship (vehicle carrier vessel), loading or unloading vehicles to/from a trailer of a car transporter, vehicle travel in a factory, or the like.

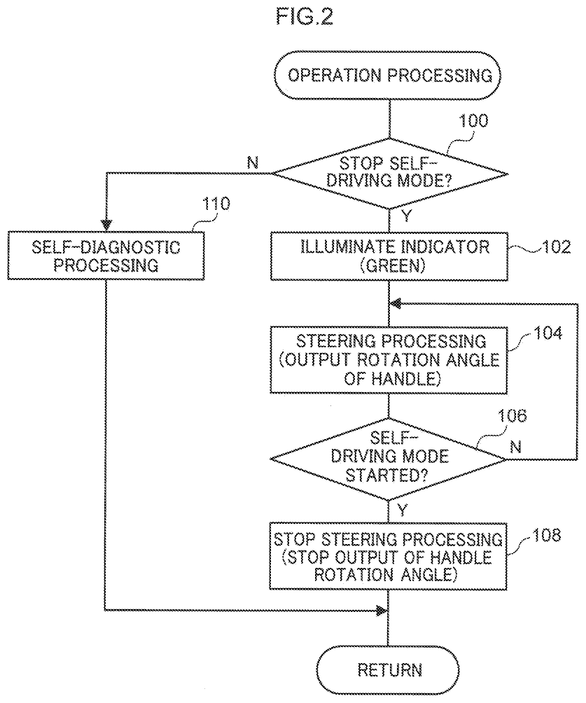

The steering system 10 is called into action by the self-driving ECU 22 stopping operation of the self-driving mode in the vehicle, thereby enabling travel in manual driving mode under driving operations by the occupant. FIG. 2 is a diagram illustrating a schematic flow of operation processing of the steering section 24 by the steering ECU 30.

In the steering system 10, operation of the steering ECU 30, together with the turning ECU 18, is started when vehicle travel is started, and operation thereof ends when vehicle travel ends. At the first step 100 in the flowchart of FIG. 2, the steering ECU 30 checks whether or not the self-driving mode has been stopped. Affirmative determination is made at step 100 (step 100: Y) and processing transitions to step 102 when the self-driving mode has been stopped, and operation of the steering section 24 is started. At step 102, the steering ECU 30 illuminates the indicator 40 provided on the handle 26 in green, providing notification to the occupant that operating of the handle 26 has been enabled. The occupant is thereby able to ascertain that the vehicle is operable in manual driving mode and that the vehicle is steerable using the handle 26.

Next, at step 104 the steering ECU 30 detects the rotation angle of the handle 26 using the rotation angle sensor 28, and outputs a signal to the turning ECU 18 according to the detected rotation angle. The self-driving signal being input from the self-driving ECU 22 stops, and by the turning ECU 18 being input with the signal from the steering ECU 30 according to the rotation angle of the handle 26, the turning ECU 18 operates the turn actuator 14 according to the input signal. The vehicle thereby travels while being steered by the handle 26.

At step 106, the steering ECU 30 checks whether or not the self-driving ECU 22 has started operation in self-driving mode, and makes negative determination al step 106 (step 106: N) as long as operation in self-driving mode has not been started, and the steering ECU 30 continues to output the rotation angle signal according to operation of the handle 26 (signal according to rotation angle) (step 104).

On the other hand, the steering ECU 30 makes an affirmative determination at step 106 (step 106:Y) and transitions processing to step 108 when the self-driving ECU 22 starts operation in the self-driving mode, stops outputting the signal according to rotation angle, and extinguishes illumination of the indicator 40. This accordingly ends manual steering in the vehicle using the steering section 24.

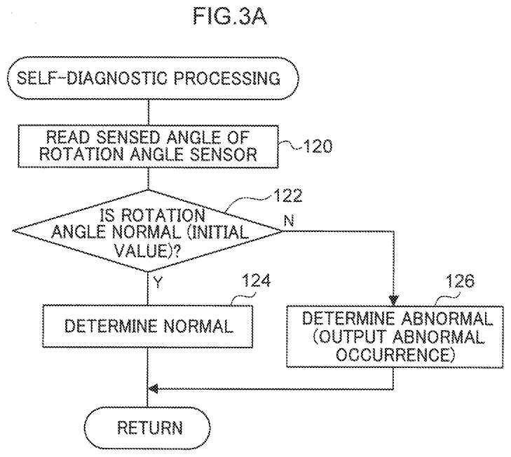

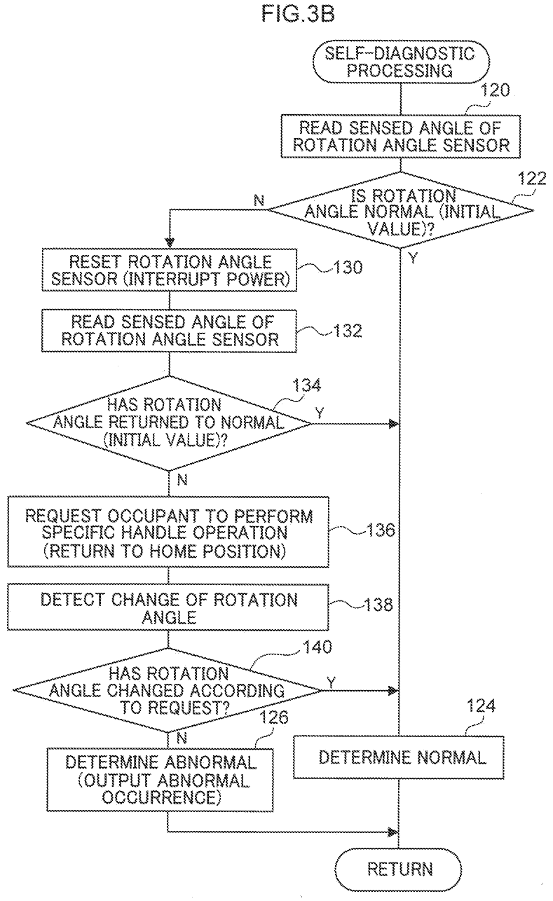

In the steering system 10, the steering ECU 30 of the steering section 24 stops outputting the signal detected by the rotation angle sensor 28 while traveling in self-driving mode, and the steering ECU 30 starts outputting the signal detected by the rotation angle sensor 28 when the self-driving mode is stopped. The steering ECU 30 makes negative determination at step 100 (step 100: N) and transitions to step 110 when the self-driving mode is not stopped, and the steering ECU 30 executes self-diagnostic processing on the steering section 24 using the rotation angle sensor 28. FIG. 3A is a diagram illustrating a flow of an example of the self-diagnostic processing executed in the steering ECU 30.

The self-diagnostic processing of FIG. 3A is executed in the steering ECU 30 at a pre-set timing, such as at each elapse of a specific period of time during vehicle travel in self-driving mode. At the first step 120 the steering ECU 30 reads the rotation angle detected (sensed) by the rotation angle sensor 28, and at step 122 the steering ECU 30 checks whether or not the detected rotation angle is normal.

The handle 26 of the steering section 24 has the home position as the initial position, and the handle 26 is held at the home position unless rotated. The rotation angle detected by the rotation angle sensor 28 in a state in which the handle 26 is positioned at the home position is the initial value of the rotation angle sensor 28. The steering ECU 30 makes affirmative determination at step 122 (step 122: Y) as long as the rotation angle detected by the rotation angle sensor 28 indicates the home position of the handle 26, and processing transitions to step 124. At step 124 the steering ECU 30 determines the steering section 24 (the handle 26 and the rotation angle sensor 28) to be in a normal state.

In contrast thereto, the steering ECU 30 makes a negative determination at step 122 (step 122: N) and transitions to step 126 unless the rotation angle detected by the rotation angle sensor 28 indicates the home position of the handle 26 (initial value of the rotation angle sensor 28). Namely, a misalignment arises between the rotation position and the home position of the handle 26 if a mechanical malfunction arises such as in cases in which the handle 26 has not been retained in the home position and has rotated when not required. This may results in the possibility that appropriate steering operation is not possible. The rotation angle sensor 28 may not be able to detect the rotation angle appropriately according to the rotation position of the handle 26 when a misalignment arises between the rotation position of the handle 26 and the rotation angle being detected, or when miss-detection or malfunction or the like occurs due to input of noise, an illicit signal, or the like. In such situations too, the possibility also arises that appropriate steering is not executable using the handle 26.

The steering ECU 30 accordingly performs abnormal determination at step 126, and outputs this determination result to the self-driving ECU 22. The self-driving ECU 22 accordingly restricts stopping of the self-driving mode, preventing travel by manual driving mode from occurring in a state in which there is no certainty of being able to perform appropriate steering. The steering ECU 30 may also illuminate the indicator 40 at step 126 in a warning color such as yellow, thereby enabling the occupant to be notified that there is a possibility that an abnormality has occurred. Note that notification of abnormal determination is preferably not executed by voice or alarm (a warning sound) or the like because travel in self-driving mode is not being impeded, and the occupant does not need to be worried excessively by the warning sound.

In FIG. 3A, a signal according to the rotation angle output from the rotation angle sensor 28 is employed so as to determine the presence or absence of an abnormality. However, self-diagnostics may be performed so as to combine determination result check processing and recovery processing. FIG. 3B is a diagram illustrating a flow of another example of self-diagnostic processing. Note that similar processing in FIG. 3B to that of FIG. 3A is appended with similar reference numerals and detailed explanation thereof will be omitted.

In FIG. 3B the steering ECU 30 transitions to step 130 when negative determination is made at step 122 (step 122: N), At step 130 the steering ECU 30 interrupts power supply to the rotation angle sensor 28 to achieve a reset state of the rotation angle sensor 28. Note that reset of the rotation angle sensor 28 is not limited to power interruption, and a method of reset that is appropriate for the rotation angle sensor 28 may be employed.

Then processing transitions to step 132, and the steering ECU 30 starts power supply to the rotation angle sensor 28, and reads the rotation angle detected by the rotation angle sensor 28. At step 134 the steering ECU 30 checks based on the rotation angle that was read whether or not the rotation angle sensor 28 has returned to normal, namely checks whether or not the detected rotation angle is the home position of the handle 26.

The steering ECU 30 makes an affirmative determination at step 134 (step 134: Y) when the rotation angle detected by the rotation angle sensor 28 is normal (the initial value), and then transitions to step 124 (normal is determined).

Moreover, the steering ECU 30 transitions to step 136 when negative determination is made at step 134 (step 134: N). At step 136, the steering ECU 30 requests the occupant to operate the handle 26. In such cases, for example, a message such as “Perform an operation check of the handle used in manual driving mode” is emitted from the speaker 42 and notified to the occupant. Then the occupant is requested to perform an operation such as, for example, “Please return the handle to the home position after first rotating the handle to the left or right”. This message may be displayed on a non-illustrated display.

Next, the steering ECU 30 checks whether or not the change in rotation angle detected by the rotation angle sensor 28 at step 138 corresponds to the request. Namely, the steering ECU 30 checks whether or not the rotation angle detected by the rotation angle sensor 28 has returned to the initial value after being changed.

The steering ECU 30 makes an affirmative determination at step 140 (step 140: Y) and transitions to step 124 in cases in which the rotation angle detected by the rotation angle sensor 28 has been changed and then returned to the initial value.

However, in cases in which the rotation angle detected by the rotation angle sensor 28 has not changed or has not returned to the initial value, the handle 26 and the rotation angle sensor 28 are unable to be determined as normal. Thus the steering ECU 30 makes negative determination at step 140 (step 140: N) and transitions to step 126. The steering ECU 30 outputs the determination result to the self-driving ECU 22 at step 126. The self-driving ECU 22 restricts stopping of the self-driving mode, prevents travel by manual driving mode from occurring in a state in which there is no certainty that appropriate steering can be performed.

In the steering section 24 of the steering system 10, while the self-driving ECU 22 is operating in the self-driving mode, the steering ECU 30 accordingly performs self-diagnostics as to whether or not a state is obtainable in which the handle 26 and the rotation angle sensor 28 operate normally. Thus whether or not the handle 26 and the rotation angle sensor 28 are able to operate normally can be ascertained while the self-driving ECU 22 is operating in the self-driving mode, Stopping of the self-driving mode and transitioning to manual driving mode is restricted from occurring in a state in Which the handle 26 and the rotation angle sensor 28 are unable to operate normally.

The steering ECU 30 uses the rotation angle sensor 28 to determine the state of the handle 26 and the rotation angle sensor 28 based on whether or not the rotation angle sensor 28 is at the initial value. There is accordingly no need to provide a new detection device to determine the state of the handle 26 and the rotation angle sensor 28, enabling an increase in the number of components to be suppressed and enabling an increase in device cost to be suppressed.

Furthermore, the steering ECU 30 requests the occupant to operate the handle 26, and the change in rotation angle corresponding to the requested operation is detected by the rotation angle sensor 28. Thus mistaken determination that the handle 26 and the rotation angle sensor 28 are in a state not to operate normally, irrespective of actually being in a state able to operate normally, can be suppressed from occurring, and the state of the handle 26 and the rotation angle sensor 28 can be ascertained appropriately.

The steering ECU 30 also outputs the determination result to the self-driving ECU 22. The self-driving ECU 22 is accordingly able to ascertain appropriately the state of the steering section 24, and the self-driving ECU 22 can be restricted from stopping operation in the self-driving mode in a state in which appropriate steering of the vehicle in the manual driving mode is unobtainable.

Note that in the present exemplary embodiment as described above the size (outer diameter) of the handle 26 is smaller than the outer diameter of a normal steering wheel. However, the operation body may have an outer diameter similar to that of a steering wheel. In such cases, the operation body may be disposed at the vehicle front side of the seat (driving seat) in which the occupant (driver) is seated similarly to with a steering wheel.

Moreover, the outer diameter of the handle 26 (operation body) may be any size the occupant is able to hold as a whole with one hand (for example, from a few centimeters to a few tens of centimeters). In such cases the operation body may be disposed at any position operable by the occupant seated in the seat (driving seat) of the vehicle, and the operation body may be disposed on an instrument panel at the vehicle front side of the occupant, disposed on a center console at the vehicle width direction inside thereof, or disposed on an inside face of a side door at the vehicle width direction outer side thereof, etc.

An example of a circular ring shaped handle 26 has been described in the present exemplary embodiment. However, the operation body may be a knob of a dial shape or a graspable shape. As long as the operation body is displaceable by being operated and the displacement is detectable, the operation body may have a trackball shape or a stick (joystick) shape. The operation body may also have a line shape or a cross shape etc. In such cases the detector may have any configuration capable of detecting displacement of the operation body when the operation body has been operated.

Note that the sensing processing, determination processing, and notification processing executed by the CPU reading software (a program) in the exemplary embodiment described above may be executed by various types of processor other than a CPU. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The processing may be executed by any one of these various types of processors, or may be executed by a combination of two or more of the same type or different types of processors (such as plural FPGAs, or a combination of a CPU and an FPGA). The hardware structure of these various types of processors is more specifically an electric circuit combining circuit elements such as semiconductor elements.

Moreover, although in the exemplary embodiment described above a mode was described in which the program for the sensing processing, determination processing, and notification processing was pre-stored (installed) on a storage medium (storage), there is no limitation thereto. The program may be provided in a format recorded on a recording medium such as a compact disk read only memory (CD-ROM), digital versatile disk read only memory (DVD-ROM), universal serial bus (USB) memory, or the like. The program may also be provided in a format downloadable from an external device over a network.

The entire content of the disclosure of Japanese Patent Application No. 2020-73979 is incorporated by reference in the present specification.

All publications, patent applications and technical standards mentioned in the present specification are incorporated by reference in the present specification to the same extent as if each individual publication, patent application, or technical standard was specifically and individually indicated to be incorporated by reference.

1. An operation device for a vehicle, the operation device comprising:
an operation body configured to be displaced by being operated so as to turn the vehicle according to a displacement of the operation body while the vehicle is being manually operated;
a detector configured to detect the displacement of the operation body so as to turn the vehicle according to the displacement of the operation body while the vehicle is being manually operated; and
a determination section configured to determine a state of the operation body and the detector based on displacement of the operation body as detected by the detector while the vehicle is in non-manual operation.

2. The operation device for a vehicle of claim 1, wherein the determination section determines whether or not a displaced position of the operation body as detected by the detector indicates a pre-defined position of the operation body.

3. The operation device for a vehicle of claim 1, wherein:
the operation device further comprises a request section configured to request a specific operation of the operation body in the non-manual operation; and
the determination section determines whether or not a displacement of the operation body corresponding to the request has been detected by the detector.

4. The operation device for a vehicle of claim 1, further comprising a notification section configured to provide notification of a determination result of the determination section.

5. An operation device for a vehicle configured to be operated manually by an occupant and to be operated by automated control, the operation device comprising:
a memory;
a processor coupled to the memory;
an operation body configured to turn the vehicle according to operation by the occupant; and
a detector configured to detect displacement of the operation body,
wherein, when the vehicle is being operated by automated control, the processor is configured to determine a state of the operation body, the detector, or any combination thereof, based on a position of the operation body as detected by the detector.

6. The operation device for a vehicle of claim 5, wherein the processor determines the state of the operation body, the detector, or any combination thereof, based on whether or not the position of the operation body as detected by the detector indicates a pre-defined position of the operation body.

7. The operation device for a vehicle of claim 5, wherein, in a case in which the position of the operation body is determined not to be at the pre-defined position of the operation body when the vehicle is being operated by automated control, the processor is configured to:
output an instruction to perform a specific operation on the operation body; and
re-determine a state of the operation body, the detector, or any combination thereof, based on a position of the operation body as detected by the detector after the specific operation has been performed on the operation body.

8. The operation device for a vehicle of claim 5, wherein, in a case in which the position of the operation body has been determined not to be at the pre-defined position of the operation body when the vehicle is being operated by automated control, the processor provides notification of the determination result to the occupant of the vehicle.
